(19) United States
(12) Patent Application Publication
(10) Pub. No.: US 2008/0298625 A1
(43) Pub. Date: Dec. 4, 2008

(54) Earphone Earhook Stabilizer

(76) Inventor: Allen Lamont Prince, Dallas, TX (US)

Correspondence Address: ALLEN L. PRINCE, 1502 OAK GLEN TRL., DALLAS, TX, 75232, US

(21) Appl. No.: 11/757,352

(22) Filed: Jun. 2, 2007

(51) Int. Cl. H04R 25/00

(52) U.S. Cl. 381/381

(57) ABSTRACT

An over-the-ear earhook comprising a horizontal behind the ear horizontal stabilizer extension or a behind the ear horizontal stabilizer extension attachment for an over-the-ear earhook for earhooks attached to an earphone worn in or over the concha cavity of a wearer's ear, the extension and earhook being adjustable generally for holding the earphone close to the wearer's ear canal and for preventing earbud type earphones from leaving the concha cavity. The extension being rigidly attached to the back of the earhook behind the wearer's ear comprising a material such as a coated wire capable of being bent and shaped to allow adjustment and thereafter maintaining its shape with sufficient rigidity to press the posterior end of the extension against the wearer's head to prevent the earhook from pivoting.

### BACKGROUND OF THE INVENTION

1. Field of the Invention

The present invention relates generally to over-the-ear earhooks for holding an earphone close to the ear canal over the pinna or exterior ear structure, in or over the concha cavity of the ear or into the opening of the ear canal itself of a wearer's ear for use in telecommunications, telephony and multimedia devices.

2. Background Art

It is becoming very common for multimedia devices to provide means for communication with tiny portable speakers and microphones that are small enough to be independently fitted to remain attached to a user's ears or single ear. A lightweight microphone may be conveniently attached to the exterior surface of the earphone that extends toward the mouth of the wearer. Some such earphones are custom fitted to securely fit within the concha cavity of the ear while others are universally constructed to fit into the ear canal without the necessity of an over-the-ear earhook. When they are not custom fitted to an individual's ear, they generally require an earhook to prevent ill fitted earphones from falling off the ear.

Some earphones fit over the concha cavity of the ear and are provided with an earhook that wraps over the front of the top region of the ear where the helix meets the side of the head, herein called the base, wrapping around the back and under the base. Many of these type earphones comprise a spring to form a clamp, pressing the cartilage reinforced plane of the helix between the earhook and the a microphone that fits over the concha. The clamping action of the earhook and earphone can be uncomfortable on the helix of the ear if the spring is too tight and such devices are usually constructed with a weak spring. The clamped earhook is generally not in contact with the side of the wearer's head behind the ear and is therefore subject to movement. The helix of the ear is the structure of the outer ear that connects to the base of the ear along the outer rim of the walls of the concha cavity 10 with the helix 8 and clamped earhooks press the plane of the helix against the earphone.

Earhooks are also used with earphones that have an earbud structure 5 that fits into the concha cavity 10 of the wearer's ear, sometimes extending into the opening of the ear canal. An earhook is a structure that attaches to the earphone 11 or a microphone that is attached to the earphone, the earhook having a structure that wraps over the top of the front of the ear 1 continuing between the plane of the helix and the side of the wearer's head over the top 4 and back of the outer side of the wall of the concha cavity extending down and under the lower regions of the ear near the earlobe for holding the earphone onto the ear. These types of earphones are generally not well suited for spring clamping the ear between the earphone and the earhook because the earbud fails to provide a surface against which the earhook is juxtaposed. The earhook provided with earbud type microphones therefore rely primarily on gravity to pull the earhook down to maintain contact with the top of the ear and rely on the shape of the lower regions of the earhook that fits around the lower regions of the base of the ear for holding the earphone onto the ear.

It is significant to note that the base of the ear is the same structure of the outer ear that comprises the wall of the concha cavity 10 along the outer rim holding the plane of the helix away from the side of the head. While the back of earhooks 4 are generally constructed to fit close to the outer back side of concha in which the earbud fits with enough space between the back of the earhook and the earbud to approximate the thickness of the concha wall, just enough space is generally allowed to avoid pinching the wall of the base of the ear along the back against the earbud and to allow easy placement and removal of the earhook and microphone leaving a significant amount of room for play back and forth between the head and the plane of the helix. Because the earhook cannot be clamped against the earbud microphone, the earbud can work its way out of the concha cavity allowing the front of the earhook to slide over the top front of the ear on which the earhook rests.

The tragus 6 and the anti-tragus 7 are cartilage reinforced structures of the ear overhanging the ear canal that can cooperate with the top and back of the inner wall of the concha cavity to assist in holding an earbud or ear canal earphone in place. Generally, mass produced earbud earphones are disk shaped shallow cylindrical structures that do not conform to the concha cavity structure such that an earbud must maintain contact with the top and back of the concha cavity 10 to assist in retaining the earhook in place at a level below the top of the choncha walls.

It can be seen that the back of an earhook when worn resides in a space between the ear and the side of the wearer's head allowing the earhook to freely slide back and forth between the ear and head while being worn adding instability along the top of the base of the ear between the plane of the helix and the side of the head allowing the earhook to pivot at the top front of the ear. A pivoting action of the earhook can allow the earbud to wobble inside the concha cavity and allow it to slide over the top of the concha cavity walls and become dislodged.

### SUMMARY OF THE INVENTION

The present invention is a stabilizing extension structure rigidly attached to the back of an earhook 4, preferably as an integrated part of the earhook at the approximate level of the concha when worn, that extends horizontally along the side and toward the back of a wearer's head 2 and preferably without the usual downward structure of earhooks extending downward behind the ear toward the earlobe. Eliminating the downward structure allows reduction of a significant amount of the size of the earhook while the stabilizing extension prevents the earhook from pivoting back and forth toward and away from the head behind the ear. The stabilizing structure preferably extends the back of an over-the-ear earhook and ends at any length back toward the back and along the side of the wearer's head while maintaining contact at any point with the side of the wearer's head while horizontally lifting the earhook away from the head and against the ear to prevent the earhook from pivoting in any direction and moving about in the space between the head and ear behind the ear.

### BRIEF DESCRIPTION OF THE DRAWINGS

The present invention will be described with reference to the accompanying drawings, wherein like reference numerals identify corresponding or like components.

FIG. 1 is a side view of an ear showing an embodiment of the present invention while being worn on the ear of a wearer;

FIG. 2 is a rear view of an ear showing an embodiment of the invention being worn on the ear of a wearer as illustrated in FIG. 1.

FIG. 3 is a side view of an ear showing another embodiment of the invention as stabilizer bar attached to a state of the art earhook being worn.

### DETAILED DESCRIPTION OF THE DRAWINGS

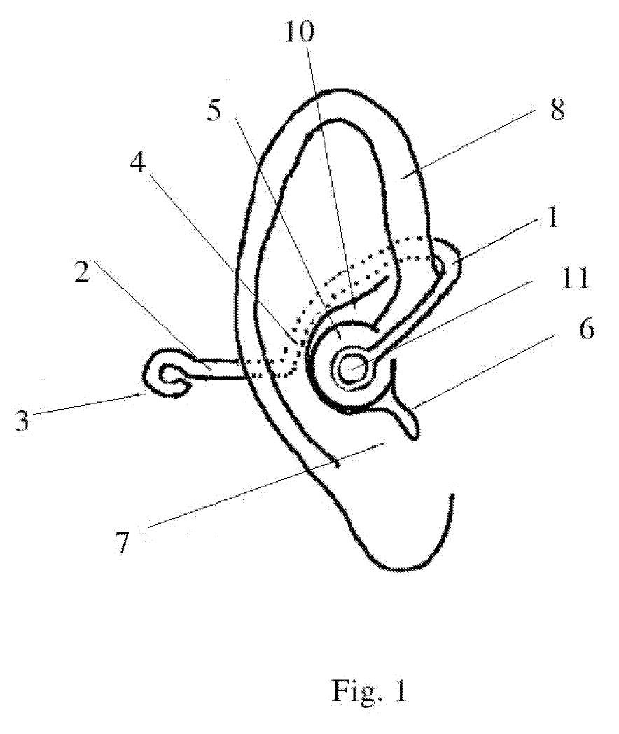

FIG. 1 shows the preferred embodiment of the invention being worn on the ear of a wearer looking directly onto the side of the head of a wearer. The figure illustrates an earbud earphone 5 being held inside the concha cavity. The earhook is shown attached to a narrowed neck 11 on the outer surface of the earbud where it is common for a microphone that is not shown might be the point of attachment to extend diagonally downward toward the mouth. The drawing shows the neck completely encircled by the earhook to form an attachment but a partially closed hook capable of clasping either the earbud speaker or an attached microphone would be comparable.

The earhook as shown is constructed by shaping a wire that is plastic coated that is stiff enough to hold its shape and yet pliable enough to be adjustable that can be shaped to extend upward and forward over the front of the helix 1 and back over the base of the ear shown to be the top 10 and back 4 wall of the concha cavity. The sharp bend in the ear hook 4 where the earhook extends back horizontally along the side of the wearer's head 2 is flattened by means of a loop at the point of contact 3 by the formation of a hook presenting a vertical surface to spread the force at the point of contact over a wider surface against the head. The top of the earhook is held against the plane of the helix by virtue of the angle at the point of connection 4 laterally toward the side of the head holding the hidden earbud earphone 5 vertically within the concha cavity.

FIG. 1 illustrates how the earphone is held confined within the concha cavity 10 in cooperation with the cartilaginous tragus 6 and anti-tragus 7 that overhangs the ear canal laterally, the earhook and the connected stabilizing structure of the invention. The points of contact with skin surfaces of the wearer at the back of the extension that is depicted in the form of a loop 3 with the side of the wearer's head and the point of contact with the back of the plane of the helix 4 lifting the back of the earhook away from the side of the head where the extension attaches to the back of the earhook 4 which need only be touching those surfaces to retain stability of the entire structure. The material comprising the connected earhook and stabilizing structure must be sufficiently rigid to hold a compliant shape but flexible enough to be adjustable to a shape that does not apply uncomfortable pressure against the surfaces of the skin at the two points of contact of the stabilizer structure between the head and the ear. The embodiment depicted comprising a loop 3 touching the side of the head is therefore optional or may comprise a terminus that is flattened to present a surface that is parallel to the side of the user's head at that point of contact.

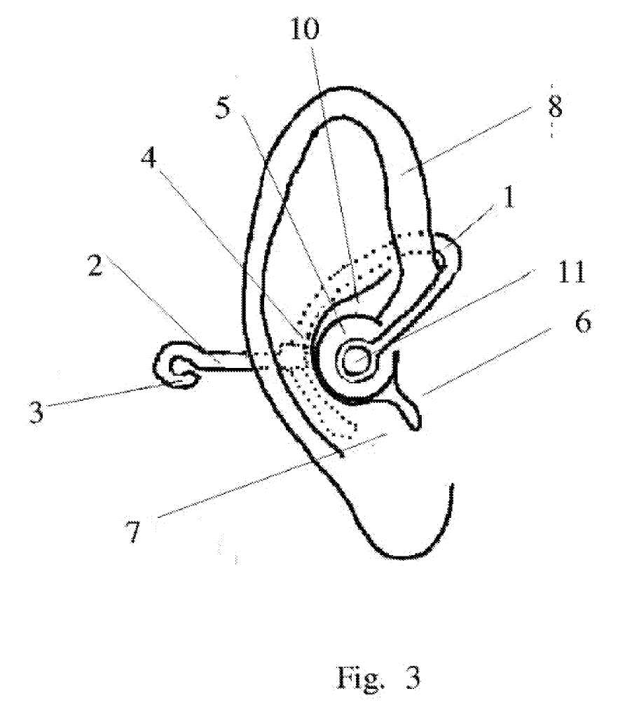

FIG. 3 depicts an embodiment of the invention as an attachable stabilizer 2 and 3 as an extension attached by a clamp along the back of a state of the art earhook 4 that extends past the point of connection between the extension 2 and the earhook extending down and forward below the anti-tragus 7 in the region of the earlobe. The clamp attaching the extension to the earhook must be a rigid connection that cannot swivel on the back of the standard earhook while the extension itself is pliable enough to allow adjustment and yet rigid enough to maintain its shape.

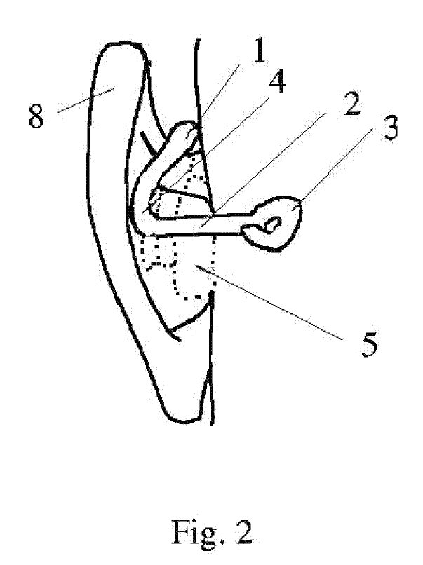

FIG. 2 illustrates the angle of the stabilizing structure at the point of connection with the horizontal tangent formed by the top of the earhook 1 in contact with the side of the head and the back end of the stabilizer extension 3 with the back of the stabilizing structure that presses against the side of the head adjusted to cause the junction between the earhook and the stabilizer extension to press against the flat plane of the under side of the ear, the surface between the head and ear in the helix region, preventing the earhook from pivoting at the top of the earhook on the top of the ear. The stabilizer extension cooperates with the earhook to press the earphone toward and against the under side of the ear and for an earbud type earphone to be pressed into the concha and remain confined within the concha cavity when adjusted to form the said angular structure along the vertical of the extension to prevent the earhook from pivoting with movement at the back of the earhook and preventing the earhook from loosely moving about in the space between the flat of the plane of the helix and the side of the head to further assure the earphone remains close to the ear and to allow stable adjustment of any microphone that may be attached to the earhook or the speaker to remain in place relative to the mouth of the wearer.

A state of the art earhook is generally a structure that is bent into a curve that when worn forms a virtual flat plane that passes through the top of ear where the helix of the ear connects to the side of the wearer's head with the earhook forming the edges of the virtual plane passing between the head and the back of the helix. The stabilizer extension cooperates with the earhook by extending the plane of the earhook and allowing the combined plane of the earhook and the extension to be bent and modified. When the extension is adjusted by being bent toward the side of the head such that the back or downward coursing structure of the earhook is pushed away from the head against the underside of the helix of the ear, movement of the back of the earhook between the back of the ear and the head is prevented such that the rigidity of the structure of the combined extension and earhook prevents the microphone from pivoting out of the concha and away from the ear and generally to prevent movement of the ear that is in contact with the earhook.

The ear structure at the point of contact along the front of the ear is generally parallel with the side of the head so that a loose fitting earhook may tend to ride up the slope of the ear where the helix meets the side of the head of a user particularly if the earbud is allowed to leave the confines of the concha cavity. The earhook that is stabilized by the invention forms a triangular set of contact points that not only cooperate to hold the earphone within the confines of the concha cavity but also prevents the earphone from fitting loosely and riding up the slope at the front of the ear and swinging away from the ear.

It may be seen in FIG. 2 that the contact point at the back of the stabilizer 3 and the earbud 5 is held in place by the contact 4 at the back of the ear. While the three contacts of the earbud 5, the contact at the front of the ear 1 and the contact against the back of the ear 4 are those commonly found in state of the art spring loaded earhooks, they do not cooperate to hold the earbud in place unless uncomfortable tension is applied by the spring and the earhook extends downward under the earlobe region of the ear.

The stabilizer attached to the earhook prevents the earhook from pivoting so that the plane of the earhook at the top forms a stable triangle with one corner lodged in the narrow space between the head and the ear at the front of ear 1 pushing against the head of the user, the second the point being where the extension connects with the back of the earhook 4 pushing against the back of the ear and the third being the distal or back end of the extension 3 forming a virtual plane generally perpendicular to the plane of the side of the head and the plane of the helix of the ear 8 holding the entire structure stable in place while holding the earphone 5 comfortably within the confines of the concha cavity 10 above the ear canal.

It may be seen that the back of the earhook comes in close proximity 4 with the circumference of the earbud earphone 5 a distance approximately the thickness of the cartilaginous wall of the concha cavity forming the base of the ear. When placing an earphone attached to an earhook over the ear, the earhook must slide over the helix and the thickness of the helix plane when placing the earhook over the ear and taking it off. Many state of the art earhooks provide a spring loaded swivel either at the attachment with the earbud, at a microphone attachment that may be attached to the earbud or along the extent between the earbud attachment and the front of the ear 1 to facilitate ease of placing the earhook over the ear. For each of these configurations, the stabilizer extension aids in securing the earhook to the ear by preventing movement after placement.

The totally rigid configuration depicted in FIGS. 1 and 3 requires that the helix plane of the ear be pulled through the hook with the fingers of one hand while holding the earhook with the other hand for maximum stability, an inconvenience that is compensated by the added security that the rigid structure provides preventing loss of the earphone and earhook. The stabilizer bar is preferably comprised of material can be bent and shaped for adjustment after the earhook is first installed onto the ear and rigid enough to maintain the shape after being adjusted. The only limitation regarding the length of the extension is the requirement that the extension spans the distance between the plane of the ear and the side of the head while any greater length serves to add stability.

What is claimed is:

1. A stabilizing structure having a front and back end wherein the front end is rigidly attached to the back of an over-the-ear earhook worn over a wearer's ear holding an earphone near the ear canal of the wearer, the stabilizing structure having a length that effectively extends contact horizontally of the earhook against the side of the wearer's head in the region behind the ear such that the front end of the extension near the point of attachment with the earhook may be adjusted to push the back of the earhook away from the side of the head and against flat surface of the ear parallel to the side of the wearer's head stably leveraging the earphone over the ear canal of the wearer by preventing the back of earhook from moving or pivoting in the space between the ear and the side of the head behind the ear of the wearer.

2. The earhook and stabilizing structure in claim 1, wherein the earhook and the stabilizing structure are constructed as a single integrated device.
